(19) United States
(12) Patent Application Publication
(10) Pub. No.: US 2026/0175236 A1
(43) Pub. Date: Jun. 25, 2026

(54) Nozzle System with Interchangeable Inserts for Cleaning Conduits

(71) Applicant: Ultra Clean Technologies Corp, Bridgeton, NJ (US)

(72) Inventors: Christopher J. Rohde, Tamaqua, PA (US); Jeffrey T. Contino, JR., Bridgeton, NJ (US); Michael McGurk, Williamstown, NJ (US)

(21) Appl. No.: 18/987,474

(22) Filed: Dec. 19, 2024

(51) Int. Cl. B05B 1/02; B08B 9/032

(52) U.S. Cl. CPC B05B 1/02; B08B 9/0321

(57) ABSTRACT

Embodiments are disclosed of a modular nozzle system for directing airflow for launching foam projectiles into and through hoses, tubes, pipes, and other conduits. Certain embodiments include a metallic shell and interchangeable inserts for accommodating various hose, tube, or piping diameters and shapes. Inserts may be fabricated using 3D-printing technology or precision machining from metal or plastic, tailored to suit specific usage scenarios. Inserts crafted from sturdier materials are used to enhance longevity and performance as compared to hoses reinforced with steel or featuring sharp edges that may cause accelerated deterioration of inserts.

### BACKGROUND

### Field of the Disclosure

The present disclosure relates to nozzles that direct airflow to propel projectiles to clean conduits such as (without limitation) hoses, tubes, and pipes.

### Description of the Related Art

A problem in the field of industrial contamination control is that of maintaining hoses, tubes, pipes, and other conduits to be contamination free to prevent costly equipment downtime or failure. For example, to control and reduce the risk of fluid power contamination, customers employ a means to clean a hose or tube, including hoses, tubes, and other conduits that may be of a non-standard size.

As part of the process of cleaning, maintainers and customers frequently use off-the-shelf nozzles to affix air pressure systems to the conduit. The off-the-shelf nozzles are made in standard size increments that can be used to focus compressed air to cause pellets to clear through conduits for cleaning or decontamination. Custom nozzles are frequently machined from a single piece of aluminum. The current process generally uses custom drawings, unique requests for price quotes, communicating prices for individualized requirements, waiting for confirmation, requesting machining in an available queue with individualized pricing, receiving parts, testing, and shipping to customers, and other steps. Therefore, the steps may include high customization costs, long lead times based on product drawings and specifications, processing and assessments of multiple quotes, time and costs of ordering, costs of shipping to a customer, and other administrative, financial, time, and logistics burdens.

There is a need for a rapid, cost-effective, customized nozzle cleaning solution for use in decontamination of various systems, including but not limited to use in hydraulic systems.

There is a need for a design that supports cleaning non-standard hose sizes, providing a cost-effective solution with standardized pricing.

There is a need for integrating many steps of design, manufacture, reducing costs, and on-demand replacement to address the shortcomings of traditional machining processes in the field.

There is a need for a faster, more efficient, and less invasive or harmful way to clean contaminated hydraulic lines, for example, by shooting a projectile through the hose or tube assembly with a pneumatic launcher. A projectile can strip out internal contamination (e.g., dirt, oil, rubber, metal shavings). Clean oil and other products frequently must stay clean on reaching components to reduce the risk of failure and system downtime. Where required, clean oil may be required to meet, for example, ISO 13/10 requirements or, for example, “18/16/13” standards under ISO 4406, which is a standard that specifies cleanliness levels of hydraulic fluids and lubricating oils, where that standard refers to particle counts at different size ranges within a specified volume of fluid, e.g., not to exceed 18 particles greater than or equal to 5 micrometers (μm) in size per milliliter of fluid, not to exceed 16 particles greater than or equal to 15 μm in size per milliliter of fluid, and not to exceed 13 particles greater than or equal to 25 μm in size per milliliter of fluid. Lower numbers indicate cleaner fluid, which is desirable for the proper functioning and longevity of hydraulic systems and machinery.

A difficulty with firing the projectiles, including smaller projectiles, is that generally nozzles require insertion into the hose or tube end. Nozzles generally have a thin-walled section at the tip that is easily damaged, bent, or chipped.

In fields where the controlled projection of foam projectiles is essential for maintenance requirements, for longevity, for cost controls, or for higher performance, conventional nozzles often lack adaptability or modularity to accommodate hoses or tubes of varied sizes to connect to projectile systems. Existing solutions are limited in their ability to provide a universal fit, resulting in inefficiencies and increased costs associated with maintaining an inventory of nozzles tailored to specific diameters.

### SUMMARY

Certain embodiments of the present disclosure address multiple challenges including those faced by customers requiring efficient cleaning of non-standard hose or tube sizes. The prevailing prior-art issues include the limitations of using off-the-shelf nozzles and the drawbacks associated with processes to create custom nozzles machined from a single piece of aluminum.

The present disclosure introduces a modular nozzle with a metal (e.g., aluminum) shell and interchangeable inserts that accommodate multiple sizes of projectiles and/or multiple tube fitting elements. Embodiments may support cleaning of non-standard hoses or hoses with attached fittings or tube sizes. Embodiments may present an efficient, cost-effective solution with standardized pricing for current requirements for customized nozzle services.

Embodiments may include a robust metallic shell that forms the primary structure. The metallic shell ensures durability and longevity, crucial for applications in demanding environments. Additionally, the disclosure introduces interchangeable inserts, allowing the nozzle to be adapted to hoses or tubes of different inner and outer diameters and shapes. Embodiments of the modular nozzle may include a robust aluminum shell ensuring durability and longevity. Interchangeable inserts allow adaptation of cleaning processes for hoses, tubes, and other conduits of varying diameters tailored for specific applications in the fields of oil and gas, chemical, agriculture, paper and pulp, pharmaceutical, food and beverage, mining, power generation, automotive, aerospace, and other industries.

Embodiments may use an integration of 3D printing technology and specific design features to enable universality to address the shortcomings of traditional machining processes. Embodiments of a standardized, lower-costing custom nozzle system would allow for ordering bulk aluminum shells (where larger lots provide economies of scale). This in turn allows for rapid responses comprised of creating 3D-printed inserts and allows for assembling, testing, certifying, and shipping a solution in a reasonable period (e.g., a 1-3-day turnaround or less).

Embodiments may therefore create cost reductions by use of shells, for example, of aluminum, from production processes incorporating bulk orders, and by creating on-demand availability of replacement inserts for ready shells. Embodiments of the disclosure may be well-suited for addressing the unique needs of small projectile sizes, providing a versatile and efficient solution for a wide range of applications, including potential use in tubing requirements for multiple environments, including terrestrial or space-based environments.

In embodiments, the 3D printed insert within a shell can be customized for non-round tube ends or hose fittings. For example, if an end of the tube has a hex-shaped fitting, or threading, or a square shape formed in the end of the tube, a 3D printed insert could be customized to fit non-round tubing ends or hose fittings.

Further, embodiments may overcome problems in the current art related to firing smaller-sized projectiles that are, in the current field, inserted into the hose or tube end using a thin-walled section of the nozzle tip that is easily damaged, bent, or chipped. Embodiments of the disclosure may hold the hose or tube on an outer diameter, preventing the need for a thin-walled section of the nozzle from being put into the inner diameter of the hose or tube, and reducing risks of damage, bending, or chipping.

Embodiments may also avoid time-consuming hook-ups and unhooking assemblies from a flush tank, determining cycle times of solvent flushes depending on hose size and length, removal of solvent after the flushing operation, cost to purchase the solvent and dispose of used solvent, maintenance of the flushing system and changing filters, health hazards to employees performing the flushing, space for the equipment, and limitations on flushing in a cleaning cell.

Embodiments may also provide a solution for customers with non-standard tube sizes, where the current alternative to a standard nozzle for projectile cleaning might be flushing. Embodiments disclosed herein are an improvement on this.

Embodiments may incorporate interchangeable inserts that may be swapped within the metallic shell to accommodate different hose or tube sizes. These inserts may be manufactured using advanced techniques such as 3D printing technology or precision machining from durable materials. The flexibility in fabrication enables tailoring the inserts to specific usage scenarios, ensuring optimal performance in diverse applications.

To further enhance the longevity and performance of the modular nozzle, embodiments may incorporate or emphasize sturdier materials for certain inserts. This contrasts with hoses reinforced with steel or featuring sharp edges, which may accelerate the deterioration of 3D printed inserts. Embodiments of the instant design may allow for customization based on the intended application, promoting a balance between durability and compatibility.

Embodiments of the system are useful to, among other factors, create a projectile-based system that carries an inexpensive initial investment to reduce oil and other contaminants, reduces total cleaning time per assembly to 10 to 15 seconds or less, supports achieving ISO-4406 & 4405 cleanliness levels, allows use in a cleaning cell or at the job site, creates an absence of chemicals or hazardous waste to dispose of, and enables a substantial and possibly complete reduction of risk to employee health issues.

### BRIEF DESCRIPTION OF THE DRA WINGS

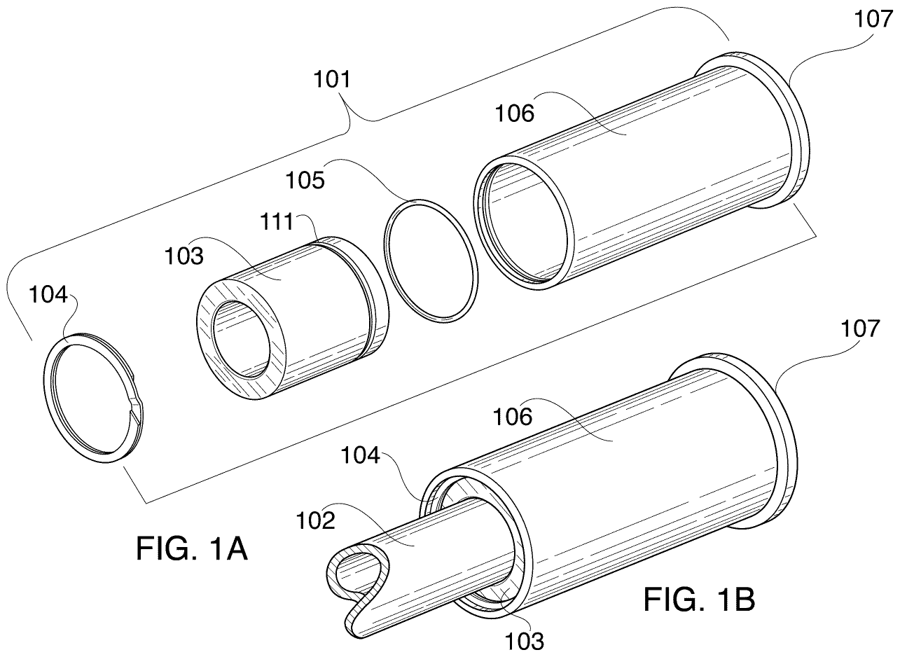

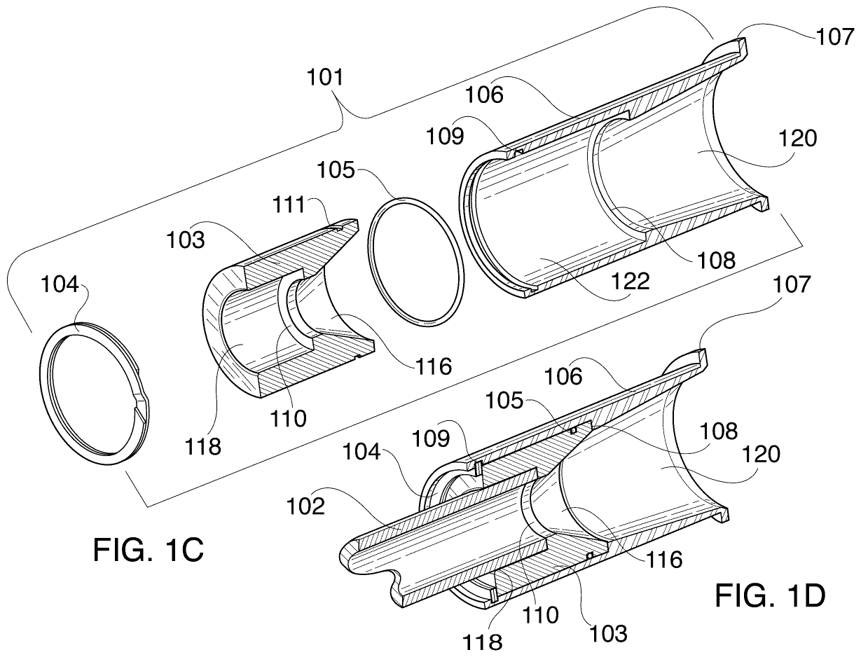

FIG. 1A is an exploded, perspective view of an example nozzle assembly for a nozzle system according to one embodiment of the disclosure;

FIG. 1B is a perspective view of the assembled nozzle assembly of FIG. 1A configured to an example conduit to be cleaned;

FIG. 1C is an exploded, partial cross-sectional, perspective view of the nozzle assembly of FIG. 1A;

FIG. 1D is a cross-sectional, perspective view of the nozzle assembly and conduit of FIG. 1B;

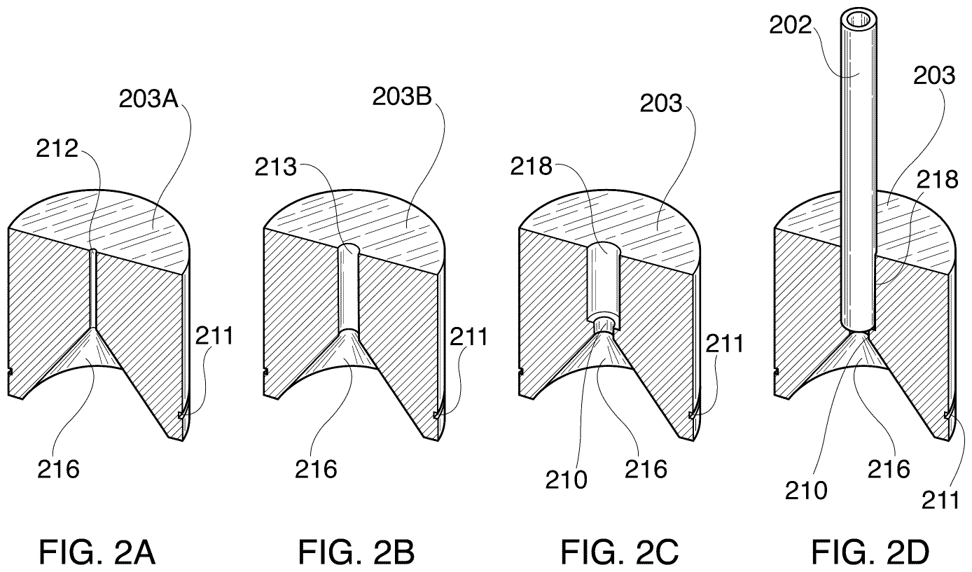

FIG. 2A is a cross-sectional, perspective view of an initial structure for an alternative, interchangeable insert for the nozzle system of FIGS. 1A-1D;

FIG. 2B is a cross-sectional, perspective view of an intermediate structure for the insert of FIG. 2A after modification;

FIG. 2C is a cross-sectional, perspective view of the final structure for the insert of FIG. 2B after further modification;

FIG. 2D is a cross-sectional, perspective view of the insert of FIG. 2C configured to an example conduit to be cleaned;

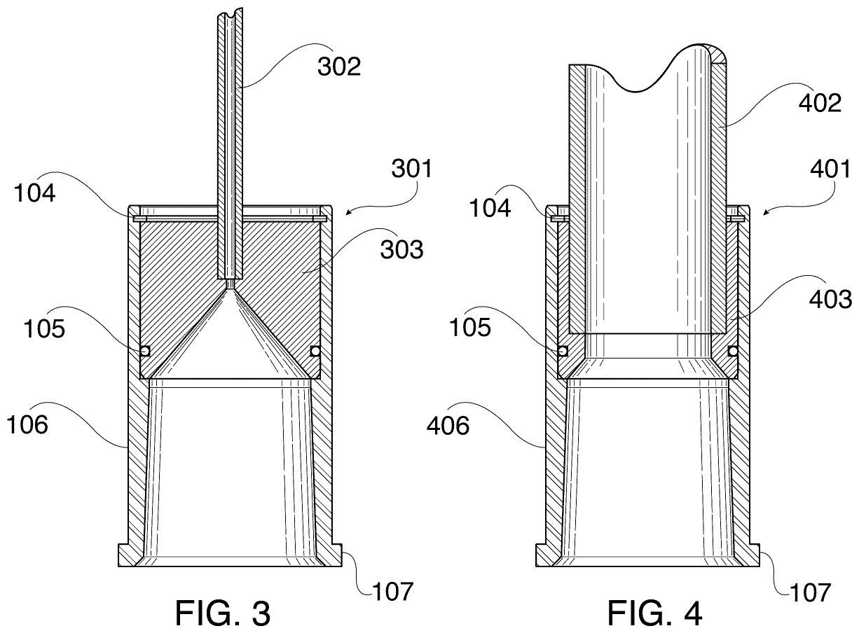

FIG. 3 is a cross-sectional, side view of yet another nozzle assembly for the nozzle system of FIGS. 1A-1D configured to an example conduit to be cleaned;

FIG. 4 is a cross-sectional, side view of yet another nozzle assembly for the nozzle system of FIGS. 1A-1D configured to an example conduit to be cleaned;

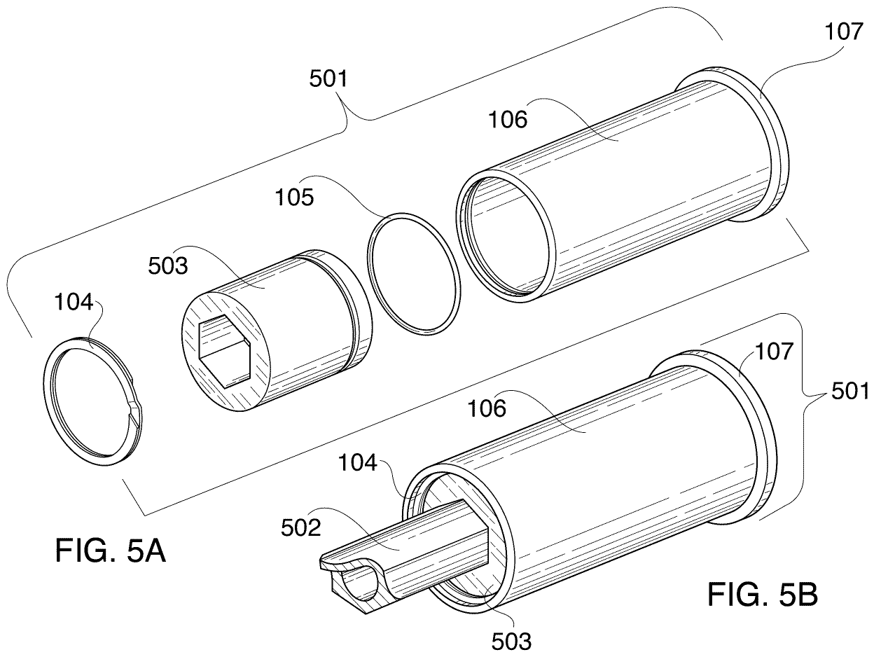

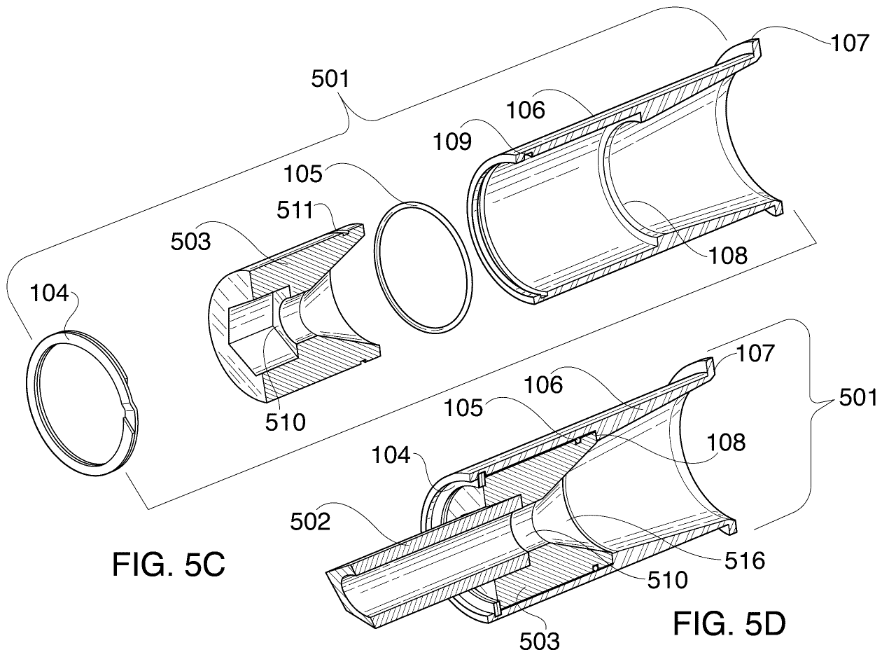

FIG. 5A is an exploded, perspective view of yet another nozzle assembly for the nozzle system of FIGS. 1A-1D;

FIG. 5B is a perspective view of the assembled nozzle assembly of FIG. 5A configured to an example conduit to be cleaned;

FIG. 5C is an exploded, partial cross-sectional, perspective view of the nozzle assembly of FIG. 5A;

FIG. 5D is a cross-sectional, perspective view of the nozzle assembly and conduit of FIG. 5B;

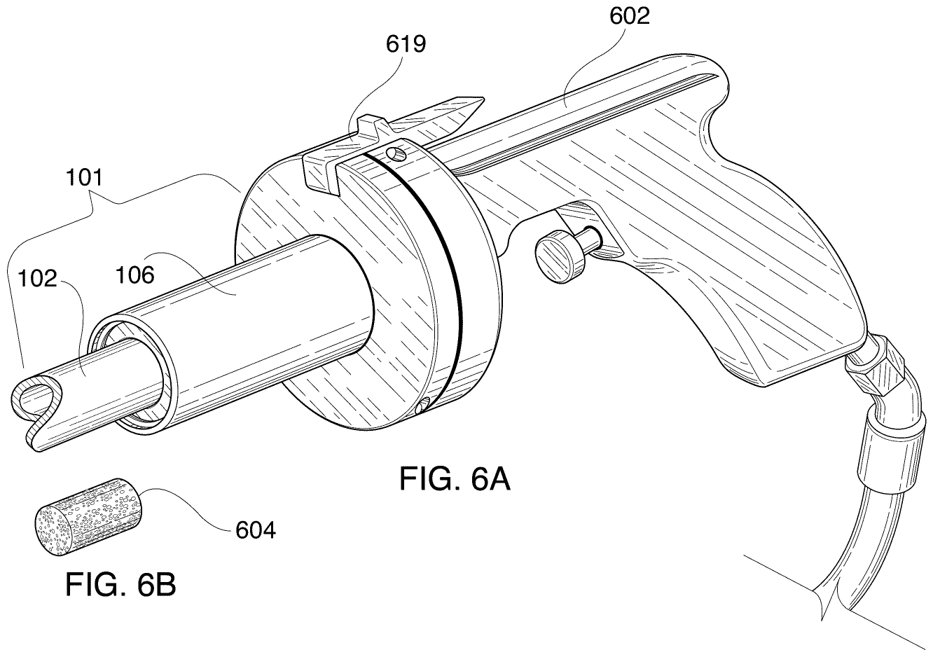

FIG. 6A is a perspective view of the nozzle assembly of FIGS. 1A-1D connected to a pellet launcher and configured to a conduit to be cleaned; and

FIG. 6B is a perspective view of a projectile for being launched through the nozzle assembly of FIGS. 1A-1D by the pellet launcher of FIG. 6A.

### DETAILED DESCRIPTION OF THE DISCLOSURE

FIG. 1A is an exploded, perspective view of an example nozzle assembly 101 for a nozzle system according to one embodiment of the disclosure. FIG. 1B is a perspective view of the assembled nozzle assembly 101 of FIG. 1A configured to an example conduit 102 to be cleaned. FIG. 1C is an exploded, partial cross-sectional, perspective view of the nozzle assembly 101 of FIG. 1A. FIG. 1D is a cross-sectional, perspective view of the nozzle assembly 101 and conduit 102 of FIG. 1B. The nozzle assembly 101 comprises a hollow, interchangeable insert 103, a snap ring 104, an O-ring 105, and a hollow shell 106.

As shown in FIG. 1C, the exterior of the insert 103 has a cylindrical shape with an O-ring groove 111 designed to receive the O-ring 105. The interior of the insert 103 has a frustum-shaped proximal section 116 and a cylindrical distal section 118, where the interface between the proximal and distal sections 116 and 118 of the insert 103 defines a conduit seat 110. The exterior of the shell 106 has a cylindrical shape with a flange 107. The interior of the shell 106 has a frustum-shaped proximal section 120 and a cylindrical distal section 122 having a snap-ring groove 109 for receiving the snap ring 104. The interface between the proximal and distal sections 120 and 122 of the shell 106 defines an insert seat 108.

As shown in FIG. 1D, with the O-ring 105 located within the insert's O-ring groove 111, the insert 103 is inserted into the shell's distal section 122 up to and abutting the insert seat 108. The snap ring 104 is then inserted into the shell's snap-ring groove 109 to retain the insert 103 within the shell 106. With the resulting nozzle assembly 101 attached to a pellet launcher, such as the pellet launcher 602 of FIG. 6A, the nozzle assembly 101 may be configured to a cylindrical conduit to be cleaned, such as the conduit 102 of FIGS. 1B and 1D, where the nozzle assembly 101 is applied to the conduit 102 with the end of the conduit 102 inserted into insert's the distal section 118 up to and abutting the insert's conduit seat 110.

Note that, as shown in FIG. 1D, the insert 103 and shell 106 are specifically designed such that:
The inner diameter of the insert's distal section 118 substantially matches the outer diameter of the conduit 102;
The outer diameter of the insert 103 substantially matches the inner diameter of the shell's distal section 122;
The distal end of the shell's frustum-shaped proximal section 120 has substantially the same diameter as the proximal end of the insert's frustum-shaped proximal section 116; and
The distal end of the insert's frustum-shaped proximal section 116 has substantially the same diameter as the inner diameter of the conduit 102.

These features ensure that the insert 103 fits snuggly into the shell 106, the conduit 102 fits snuggly into the insert 103, and the flow of air and pellets, such as the pellet 604 of FIG. 6, from the pellet launcher 602 through the nozzle assembly 101 and into the end of the conduit 102, is smooth. Note that, in the embodiment of FIGS. 1A-1D, the angle of the shell's frustum-shaped proximal section 120 is smaller than the angle of the insert's frustum-shaped proximal section 116. In other embodiments, those angles may be substantially equal or the angle of the shell's frustum-shaped proximal section 120 may be greater than the angle of the insert's frustum-shaped proximal section 116 as long as their inner diameters are substantially equal at the transition between those two sections.

Note further that, because the nozzle assembly 101 receives the conduit 102 into the open end of the insert 103 rather than the open end of the conduit 102 receiving the end of the nozzle assembly as in the prior art, the distal end of the insert 103 does not have to be thin-walled and therefore brittle. Rather, the distal end of the insert 103 can be as thick-walled as needed to make the nozzle assembly 101 sufficiently sturdy and durable.

Note that the nozzle assembly 101 of FIGS. 1A-1D is just one possible assembly for the nozzle system of FIGS. 1A-1B. As described below, the nozzle system of FIGS. 1A-1D encompasses any suitable number of different nozzle assemblies, where each nozzle assembly employs the same snap ring 104, O-ring 105, and shell 106 of FIGS. 1A-1D, but a different, interchangeable insert designed for a different size and/or different shape conduit. The nozzle system of FIGS. 1A-1D also allows the same snap ring 104, O-ring 105, and shell 106 of FIGS. 1A-1D to be used with replacement inserts as existing inserts wear out through repeated use.

FIGS. 2A-2D are cross-sectional, perspective views illustrating the manufacturing of an alternative, interchangeable insert 203 for the nozzle system of FIGS. 1A-1D. The creation of the interchangeable insert 203 may occur in different ways. One way, for illustration purposes, is to print or otherwise manufacture an initial structure 203A for the insert 203 to include a relatively narrow pilot hole 212 as show in FIG. 2A. Note that the initial structure 203A already has the outer shape and size, the O-ring groove 211, and the frustum-shaped, proximal section 216 for the insert 203. The pilot hole 212 may then be widened by first drilling (or by using other techniques) to create a modified hole 213, as shown in FIG. 2B. Note that the inner diameter of the modified hole 213 is designed to match the inner diameter of the conduits to be cleaned using the insert 203, such as conduit 202 of FIG. 2D. As shown in FIG. 2C, the cylindrical, distal section 218 and the conduit seat 210 of the insert 203 may be finalized for a given use by widening most, but not all of the modified hole 213 of FIG. 2B. Note that the inner diameter of the insert's distal section 218 is designed to substantially match the outer diameter of the conduits to be cleaned using the insert 203, such as conduit 202 of FIG. 2D. As such, the conduit 202 as should then fit firmly into the distal section 218 of the interchangeable insert 203 up to and abutting the insert's conduit seat 210, as shown in FIG. 2D.

Note that:
The insert 203 has an outer diameter substantially identical to the outer diameter of insert 103 from FIGS. 1A-1D, and an analogous O-ring groove 211 such that insert 203 can be inserted into the distal section 122 of the shell 106 of FIGS. 1A-1D up to and abutting the shell's insert seat 108;
The insert 203 has a frustum-shaped, proximal section 216 whose diameter at the proximal end substantially matches the diameter of distal end of the shell's frustum-shaped, proximal section 120;
The insert 203 has a cylindrical, distal section 218 of a size different from that of the insert 103 of FIGS. 1A-1D in order to receive conduits having different outer and inner diameters; and
The insert 203 is manufactured to create a conduit seat 210 as shown in FIG. 2C for receiving the proximal end of the conduit 202, where the diameter at the distal end of the insert's proximal section 216 substantially matches the inner diameter of the conduit 202.

FIG. 3 is a cross-sectional, side view of another nozzle assembly 301 for the nozzle system of FIGS. 1A-1D configured to a relatively small conduit 302 to be cleaned. Note that, in addition to the same snap ring 104, O-ring 105, and shell 106 of FIGS. 1A-1D, the nozzle assembly 301 comprises an insert 303 designed for the small size of conduit 302.

FIG. 4 is a cross-sectional, side view of another nozzle assembly 401 for the nozzle system of FIGS. 1A-1D configured to a relatively large conduit 402 to be cleaned. Note that, in addition to the same snap ring 104, O-ring 105, and shell 106 of FIGS. 1A-1D, the nozzle assembly 401 comprises an insert 403 designed for the large size of conduit 402.

FIGS. 5A-5D show analogous, respective views of another nozzle assembly 501 for the nozzle system of FIGS. 1A-1D. Note that, in addition to the same snap ring 104, O-ring 105, and shell 106 of FIGS. 1A-1D, the nozzle assembly 501 comprises an insert 503 designed for the conduit 502 having a hexagonal outer shape.

FIG. 6A is a perspective view of the nozzle assembly 101 of FIGS. 1A-1D connected to a pellet launcher 602 and configured to the conduit 102 to be cleaned. The nozzle assembly 101 may connect to the launcher 602 in different ways, including by placing the shell's flange 107 (not shown in FIG. 6A) within the launcher 602 and controlling the position of the nozzle assembly 101 with a suitable fastener system 619. FIG. 6B is a projectile 604 for being launched through the nozzle assembly 101 of FIGS. 1A-1D by the pellet launcher 602 of FIG. 6A. The projectile 604 may be a foam pellet, compressible and sized slightly larger than the diameter of a conduit 102. For locking the nozzle into place, the locking steps may include not only having a user load the nozzle assembly 101 into a locking ring and securing the flange 107, but alternatively screwing or snapping a locking ring onto the launcher 602, or other means. For many embodiments, tools might be required, if at all, for removing the snap ring to swap inserts. This may be performed, for example, if multiple inserts are needed for multiple custom hose, tube, pipe, or other conduit sizes.

While FIGS. 1A-1D, 3, 4, and 5A-5D disclose use of a snap ring 104 towards the front of the nozzle assembly, alternative embodiments may have the snap ring and corresponding radial slot disposed further to the rear end of the system. The snap ring 104 supports a secure control of the interchangeable inserts, retaining the insert (e.g., 103 of FIG. 1A) from advancing out of the tip of the nozzle shell 106. In an alternative embodiment, the insert 103 in FIG. 1A could also be held in place by a set screw through the shell 106. The insert 103 could also be screwed into the shell with an external thread on the insert 103, and a corresponding internal thread within the shell 106. Inserts 103, 203 may also have threads or other fittings to connect hoses, tubes, pipes, or other conduits. Embodiments securing the system with a screw or similar applications may need to be monitored to ensure that the screw does not loosen after multiple uses. An alternative embodiment could use threading, a pin, a temporary thread compound, or other alternative fixation techniques to secure the insert 103, 203, etc. Other fixation techniques may include glue/epoxy, press fit, welding, brazing, threaded connection, keyed fit, pinning, compression fitting, retaining compound, collar, collet, clamp, spring clip, and magnetic fixing.

Note that the O-ring 105 may be placed as shown in FIGS. 1A-1D, 3, 4, and 5A-5D, or may be located forward or aft of the relevant location, as long as the function is maintained of reducing the risk of air passing around the outer diameter of the interchangeable insert (e.g., 103 of FIG. 1A).

Regarding alternative materials, while the shell 106 may be made of a durable metallic material to form the primary structure, the shell 106 may also be made of robust nylon, an alternative plastic or rubber-based composite, or another suitable material that ensures durability in demanding environments and applications. As can be understood by one of ordinary skill in the art, interchangeable inserts 103-503 may be fabricated from metal, plastic, or 3D printing materials or other suitable substances with sufficiently durable properties, may be customized for specific diameters, to enhance versatility and adaptability of the nozzle assemblies. Multiple circumstances may arise in challenging environments for cleaning hydraulic or other systems that involve fluids, contaminants, sharp edges, or different lengths and diameters of the conduit to be cleaned.

Because the materials disclosed will be used in a high-pressure environment with potentially substantial friction, and due to the presence of contaminants and other materials in conduits, there is a risk of multiple surfaces wearing out over time. For example, if 3D print material were to degrade, this could cause contamination of the conduit, leaving microplastics that could enter the conduit. For this reason, use of various embodiments may suggest a recommended set lifetime for using the 3D-printed inserts, or for the other elements in the nozzle system such as the snap ring 104, O-ring 105, and shell 106 of FIG. 1A. To avoid risks from certain solvents or cleaning agents that may negatively affect the 3D print material or other materials comprising elements of the nozzle system, it may be recommended that the default use be with dry projectiles without any cleaning chemicals, or if with cleaning chemicals, the set lifetime may be reassessed. A benefit of the modularity in the instant disclosure is the low cost of allowing a user to swap inserts when wear is noticed due to rubbing with internal elements to include inner surfaces or edges of a conduit. It is further noted that, for an aluminum shell, the 3D-printed insert should be shielded from significant stress from repeated use.

As an example of a specific embodiment useful for multiple purposes, the shell 106 may have dimensions of about 40-45 mm in outer diameter and about 80 mm in length. An embodiment may include sections comprised of a series of chamber sections of different internal diameters, as well as at least one chamfer, for example, machined to approximately 4°. A nozzle assembly may be used in the cleaning and decontamination of a ⅛″ or a 4½″ hose, tube, or pipe. The nozzle system may be attached or coupled to a 360-degree rotary plug for efficient and forceful air flow and non-fatigue operator use. The launcher 602 may require a UC-AR2 adapter ring for nozzles ⅛″ through 1¼″ and a UC-AR3 for nozzles 1½″ and 2″. A UC-U55/90 universal nozzle 2⅛″ through 3½″ (55 mm-90 mm ID) may not require an adapter ring. The embodiment may involve precision-machined aluminum, anodized for harsh environments and heavy use. Embodiments may be used in hose and tube shops, or mobile hose fabricators and job site applications because of its simplistic design, size, and portability.

For some industry applications, it may be convenient to accommodate a hose or tube size range of up to a 36 mm, and an accompanying shell of 6061 Aluminum, Blue Anodized, for safety and for ease of reference against Federal 595c color-matching standard color code 35183. In some embodiments or applications of embodiments, where the launcher is used for applications with a large diameter hose, tube, pipe, or other conduit, a deeper insertion depth to maximize the ratio of bearing surface to bearing diameter may be required.

The above discloses components of a modular nozzle system to create a versatile, adaptable, and high-performance solution for directing airflow and delivering projectiles across a diverse array of applications. The modular nozzle system can be utilized in multiple ways, for both hand launchers for manual launching and bench-mounted equipment for automated systems, providing flexibility in various operational environments.

In certain embodiments, the present disclosure is a nozzle system for cleaning conduits, the nozzle system comprising a nozzle shell adapted to (i) be connected, at a proximal end of the nozzle shell, to a pellet launcher and (ii) receive, at a distal end of the nozzle shell, a proximal end of a nozzle insert adapted to receive, at a distal end of the nozzle insert, a proximal end of a conduit to be cleaned, the nozzle shell comprising a proximal section and a distal section, wherein a transition between the proximal section and the distal section of the nozzle shell defines an insert seat adapted to stop insertion of the nozzle insert into the distal section of the nozzle shell.

In at least some embodiments, the nozzle system may incorporate a nozzle shell adapted to receive any one of a plurality of instances of the nozzle insert having distal sections adapted to receive proximal ends of conduits of different size and/or shape.

In at least some embodiments, the nozzle system may incorporate a plurality of the instances of the nozzle insert.

In at least some embodiments, the nozzle system may incorporate a nozzle shell adapted to (i) be connected, at a proximal end of the nozzle shell, to a pellet launcher and (ii) receive, at a distal end of the nozzle shell, a proximal end of a nozzle insert adapted to receive, at a distal end of the nozzle insert, a proximal end of a conduit to be cleaned, the nozzle shell comprising a proximal section; and a distal section, wherein a transition between the proximal section and the distal section of the nozzle shell defines an insert seat adapted to stop insertion of the nozzle insert into the distal section of the nozzle shell, and further comprising a nozzle insert.

In at least some embodiments, the nozzle system may incorporate an outer O-ring groove adapted to receive an O-ring to form a seal between the nozzle insert and the nozzle shell.

In at least some embodiments, the nozzle system may incorporate a nozzle insert having a frustum-shaped, proximal section and a distal section adapted to receive the proximal end of the conduit.

In at least some embodiments, the nozzle system may incorporate a transition between the proximal section and the distal section of the nozzle insert defines a conduit seat adapted to stop insertion of the conduit into the distal section of the nozzle insert.

In at least some embodiments, the nozzle system may incorporate a proximal section of the nozzle shell being frustum-shaped; the distal section of the nozzle shell being cylindrical; the proximal section of the nozzle shell having a distal end having a diameter that matches a diameter of a proximal end of the proximal section of the nozzle insert; and the conduit seat having an inner diameter that matches an inner diameter of the conduit.

In at least some embodiments, the nozzle system may incorporate a nozzle system wherein the distal section of the nozzle shell has a snap-ring groove adapted to receive a snap ring to retain the nozzle insert within the distal section of the nozzle shell.

In at least some embodiments, the nozzle system may incorporate a proximal section of nozzle shell is frustum-shaped; and the distal section of the nozzle shell is cylindrical.

In at least some embodiments, the nozzle system may incorporate a nozzle shell comprised a material selected from the group of aluminum, steel, polymer, rubber, nylon, titanium, brass, bronze, zinc, plastics, and composites.

In at least some embodiments, the nozzle system may incorporate a nozzle insert is fabricated from plastic using 3D printing technology.

In at least some embodiments, the nozzle system may incorporate a nozzle insert fabricated from a material selected from the group of aluminum, steel, titanium, brass, bronze, zinc, plastics, polymers, rubber, nylon, and composites.

In at least some embodiments, the nozzle system may incorporate a nozzle insert wherein the nozzle insert has an outer O-ring groove adapted to receive an O-ring to form a seal between the nozzle insert and the nozzle shell; the nozzle insert has a frustum-shaped, proximal section and a distal section adapted to receive the proximal end of the conduit; a transition between the proximal section and the distal section of the nozzle insert defines a conduit seat adapted to stop insertion of the conduit into the distal section of the nozzle insert; the proximal section of the nozzle shell is frustum-shaped; the distal section of the nozzle shell is cylindrical; the proximal section of the nozzle shell has a distal end having a diameter that matches a diameter of a proximal end of the proximal section of the nozzle insert; the conduit seat has an inner diameter that matches an inner diameter of the conduit; and the distal section of the nozzle shell has a snap-ring groove adapted to receive a snap ring to retain the nozzle insert within the distal section of the nozzle shell.

In at least some embodiments, the nozzle system may incorporate a nozzle system, wherein the nozzle shell is adapted to receive any one of a plurality of instances of the nozzle insert having distal sections adapted to receive proximal ends of conduits of different size and/or shape.

In at least some embodiments, the nozzle system may incorporate a nozzle system further comprising the plurality of the instances of the nozzle insert.

The order in which the operations have been described above is exemplary and is not intended to indicate that the described order is the only order in which the operations could be performed. One of ordinary skill in the art would recognize various ways to reorder the operations described herein.

The foregoing description, for purpose of explanation, has been described with reference to specific embodiments. However, the illustrative discussions above are not intended to be exhaustive or to limit the various described embodiments to the precise forms disclosed. Many modifications and variations are possible in view of the above teachings. The embodiments were chosen and described to best explain the principles of the various described embodiments and their practical applications, to thereby enable others skilled in the art to best utilize the various described embodiments with various modifications as are suited to the particular use contemplated.

1. A nozzle system for cleaning conduits, the nozzle system comprising a nozzle shell adapted to (i) be connected, at a proximal end of the nozzle shell, to a pellet launcher and (ii) receive, at a distal end of the nozzle shell, a proximal end of a nozzle insert adapted to receive, at a distal end of the nozzle insert, a proximal end of a conduit to be cleaned, the nozzle shell comprising:
a proximal section; and
a distal section, wherein a transition between the proximal section and the distal section of the nozzle shell defines an insert seat adapted to stop insertion of the nozzle insert into the distal section of the nozzle shell.

2. The nozzle system of claim 1, wherein the nozzle shell is adapted to receive any one of a plurality of instances of the nozzle insert having distal sections adapted to receive proximal ends of conduits of different size and/or shape.

3. The nozzle system of claim 2, further comprising the plurality of the instances of the nozzle insert.

4. The nozzle system of claim 1, further comprising the nozzle insert.

5. The nozzle system of claim 4, wherein the nozzle insert has an outer O-ring groove adapted to receive an O-ring to form a seal between the nozzle insert and the nozzle shell.

6. The nozzle system of claim 4, wherein the nozzle insert has a frustum-shaped, proximal section and a distal section adapted to receive the proximal end of the conduit.

7. The nozzle system of claim 6, wherein a transition between the proximal section and the distal section of the nozzle insert defines a conduit seat adapted to stop insertion of the conduit into the distal section of the nozzle insert.

8. The nozzle system of claim 7, wherein:
the proximal section of the nozzle shell is frustum-shaped;
the distal section of the nozzle shell is cylindrical;
the proximal section of the nozzle shell has a distal end having a diameter that matches a diameter of a proximal end of the proximal section of the nozzle insert; and
the conduit seat has an inner diameter that matches an inner diameter of the conduit.

9. The nozzle system of claim 1, wherein the distal section of the nozzle shell has a snap-ring groove adapted to receive a snap ring to retain the nozzle insert within the distal section of the nozzle shell.

10. The nozzle system of claim 1, wherein:
the proximal section of nozzle shell is frustum-shaped; and
the distal section of the nozzle shell is cylindrical.

11. The nozzle system of claim 1, where the nozzle shell is comprised of a material selected from the group of aluminum, steel, polymer, rubber, nylon, titanium, brass, bronze, zinc, plastics, and composites.

12. The nozzle system of claim 1, where the nozzle insert is fabricated from plastic using 3D printing technology.

13. The nozzle system of claim 1, where the nozzle insert is fabricated from a material selected from the group of aluminum, steel, titanium, brass, bronze, zinc, plastics, polymers, rubber, nylon, and composites.

14. The nozzle system of claim 1, further comprising the nozzle insert, wherein:
the nozzle insert has an outer O-ring groove adapted to receive an O-ring to form a seal between the nozzle insert and the nozzle shell;
the nozzle insert has a frustum-shaped, proximal section and a distal section adapted to receive the proximal end of the conduit;
a transition between the proximal section and the distal section of the nozzle insert defines a conduit seat adapted to stop insertion of the conduit into the distal section of the nozzle insert;
the proximal section of the nozzle shell is frustum-shaped;
the distal section of the nozzle shell is cylindrical;
the proximal section of the nozzle shell has a distal end having a diameter that matches a diameter of a proximal end of the proximal section of the nozzle insert;
the conduit seat has an inner diameter that matches an inner diameter of the conduit; and
the distal section of the nozzle shell has a snap-ring groove adapted to receive a snap ring to retain the nozzle insert within the distal section of the nozzle shell.

15. The nozzle system of claim 14, wherein the nozzle shell is adapted to receive any one of a plurality of instances of the nozzle insert having distal sections adapted to receive proximal ends of conduits of different size and/or shape.

16. The nozzle system of claim 15, further comprising the plurality of the instances of the nozzle insert.
